(19) United States
(12) Patent Application Publication
(10) Pub. No.: US 2012/0000714 A1
(43) Pub. Date: Jan. 5, 2012

(54) FOOD PRODUCT SCALE AND RELATED PROMOTIONAL SYSTEM AND METHOD

(75) Inventors: Robert J. Weisz, Thornhill (CA); Robert J. Schuller, Troy, OH (US)

(73) Assignee: Premark FEG L.L.C., Wilmington, DE (US)

(21) Appl. No.: 13/224,947

(22) Filed: Sep. 2, 2011

Related U.S. Application Data
(62) Division of application No. 11/838,420, filed on Aug. 14, 2007.
(60) Provisional application No. 60/845,369, filed on Sep. 18, 2006.

(51) Int. Cl. G01G 19/40; B41F 33/00

(52) U.S. Cl. 177/25.15; 101/483

(57) ABSTRACT

A product pricing and incentive system uses a label supply in which continuous label stock has a series of laterally extending weakening lines spaced apart to define multiple label segments of common size. Single segment labels or multiple segment labels can be printed and output by a printing device based on whether an incentive-free product pricing label is to be produced or a combined product pricing and incentive label is to be produced.

### CROSS-REFERENCES

This application claims the benefit of U.S. provisional application No. 60/845,369, filed Sep. 18, 2006, the entirety of which is incorporated herein by reference.

### TECHNICAL FIELD

The present invention relates generally to in-store scales utilized for weighing food products and printing labels applied to weighed products, and more particularly, to a method and system for enhancing the effectiveness of promotions/incentives via an in-store scale.

### BACKGROUND

The perishable foods sections of most supermarkets and grocery stores such as the meat department, bakery, deli and produce department, typically include one or more in-store scales having printers for printing labels with item name, weight or count, and price information. The labels are then applied to the packaged items. Many such printers are provided as part of in-store scales systems including scales.

It is known to utilize such in-store scale systems to print coupons, or other types of promotions, as part of, or separate from, product pricing labels in order to cross-market another store item based upon a specific food item being weighed at the scale. Printing coupons on demand for incentive items based upon identity of the product weighed provides the advantage of enabling CPG (consumer packaged goods) manufacturers to select in advance the circumstances in which their coupons are distributed. However, in such systems their may be instances where coupons are not printed when certain items are weighed. It would be desirable to provide a system capable of selective coupon printing and/or promotion/advertisement and/or supplemental information printing while at the same time reducing use of label stock in those situations where the coupon and/or promotion/advertisement and/or supplemental information are not printed.

### SUMMARY

In one aspect, a method for selectively producing either a combined product pricing and incentive label or an incentive-free product pricing label in a retail store is provided. The method involves: providing a food product scale system within the retail store, the food product scale system having an associated label printer with a label supply, where the label supply is comprised of a continuous label stock having a series of laterally extending weakening lines spaced apart to define multiple label segments of common size; identifying an item to be weighed and priced; based upon identity of the item to be weighed and priced, determining whether an incentive is to be printed for the item, and: (a) if a determination is made that an incentive is to be printed for the item: the label scale system printer prints a combined product pricing and incentive label in which product pricing information is printed on a first label segment of the label supply and incentive information is printed on a second label segment of the label supply; the combined product pricing and incentive label is separated as a multi-segment label from the label supply at a weakening line and applied to the weighed item; (b) if a determination is made that an incentive is not to be printed for the item: the label scale system printer prints an incentive-free product pricing label in which product pricing information is printed on a single label segment of the label supply; the product pricing label is separated as a single-segment label from the label supply at a weakening line and applied to the weighed item.

In another aspect, a method for selectively producing product labels in different lengths, the method comprising the steps of: providing a printer system having an associated label supply, where the label supply is comprised of a continuous label stock having a series of laterally extending weakening lines spaced apart to define multiple label segments of common size; identifying an item for which a label is to be printed; based upon identity of the item, determining an integer number N of label segments on which to print, where N is 1 or more; and the label scale system printer prints and outputs a label having N label segments, where information is printed on each of the N label segments.

### BRIEF DESCRIPTION OF DRAWINGS

FIG. 1 is a schematic of a weighing scale linked with multiple computer systems;

FIG. 2 is a schematic plan of an exemplary store with multiple departments where weighing scales could be utilized;

FIG. 3 a top view of a label supply;

FIG. 4 is a side elevation of the label supply of FIG. 3;

FIG. 5 is a schematic representation of a weighing scale with label supply;

FIG. 6 is a plan view of a combined product pricing and coupon label produced using the label supply;

FIG. 7 is a perspective showing application of the product pricing and coupon label of FIG. 6 to a product;

FIG. 8 is a plan view showing a product pricing label produced using the label supply;

FIG. 9 shows the label of FIG. 8 applied to a product;

FIG. 10 is another embodiment of a label produced with the label supply; and

FIG. 11 shows the label of FIG. 10 applied to a product.

### DESCRIPTION

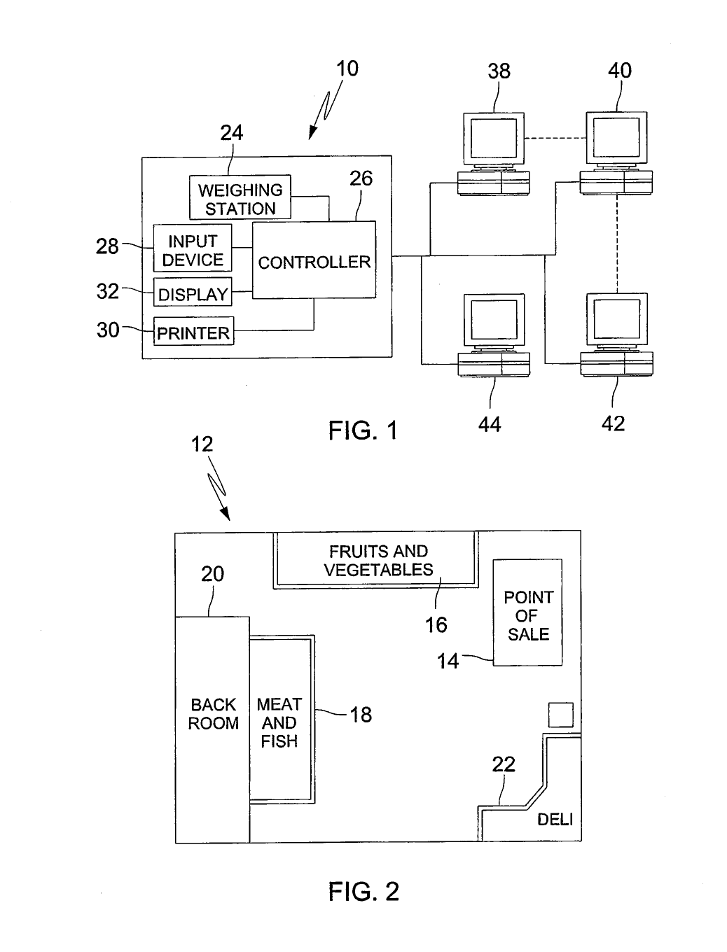

In one embodiment, a food product scale 10 (FIG. 1) is used to provide incentives at desired locations within the store 12 (FIG. 2). The store 12 may typically include a point of sale 14 with associated check out scanning terminals. The scale 10 is preferably located at another location, such as a perishables department as represented by the fruit and vegetable department 16, the meat and fish department 18 or associated back room 20, or the deli department 22 or the bakery department (not shown) so that incentives can be provided to customers prior to the actual purchase of (i.e, payment for) any products and prior to the customer being on the way out of the store.

Referring again to FIG. 1, the scale 10 includes an associated weighing station 24 having a load cell or other known weighing mechanism or device to produce weight indicative signals that are passed to a processor-based controller 26. A user input device 28 (such as a keypad, a touch sensitive display, a scanner, etc) is also connected to the controller 26. The user input device 28 may be utilized by store personnel (or in the case of a self service situation the customer) to identify the product being weighed, usually by a PLU (price look-up) number. Item identifiers for products being weighed may take other forms as well. For example, the input device could comprise a large number of keys, one for each product that might be weighed or the scale could include a more advanced image-based, RF-based or other food product identification arrangement. The controller 26 refers to a price database (stored in suitable memory of the controller or accessible via a link to another computer system such as a P.O.S. system or other in-store system or a regional or national computer system of a store chain) to identify the price per unit weight linked to the entered PLU or other product identifier, and calculates a total price for the product based upon the weight as indicated by the weight indicative signals received from the weighing station 24. The controller 26 then establishes product print data (such as total price, price per unit weight, product bar code, logos or other image data, label set-up and format) to be delivered to a printing mechanism 30. The printing mechanism 30 includes a print head and associated supply of labels to be applied to products once the product print data is printed on a label (“product label”) and the product label is output. The print head may be a thermal print head, with the labels including a thermally activated layer. However, it is recognized that other print head types and corresponding label types could be used. The adhesive side of the labels may be entirely or partially coated with adhesive. The labels may be formed of any suitable material. The various components of the scale 10 could be integrated into a single housing or unit. Alternatively, the scale 10 may be formed of components formed as separate units and connected together for communication with each other, in which case the controller may be a distributed controller, with various control functions distributed among the components. As used herein the terminology “controller” is intended to encompass the distributed controller configuration. Further, the term “controller” is intended to broadly encompass the collection of circuits, processors and other components that carry out the various operating and processing functions of the scale and its component parts.

To provide marketing incentives from the scale 10, the controller 26 also accesses an incentive database or database(s) (stored in suitable memory of the controller or accessible via a link to another computer system such as a P.O.S. system 38 or other in-store system 44 or a regional 40 or national 42 computer system of a store chain (or a third party coupon management company or system) that identifies incentives linked to specific products based upon the PLU number or other product identifier. The incentive database could be incorporated into the price database or could be a separate database. The incentive database identifies whether there is an incentive linked to the product that is weighed and for which a product label having price information is printed. If there is an incentive linked to the product, the incentive database also identifies the details of the incentive. By way of example, the incentive link could be the incentive (e.g., graphics and verbiage) itself, could be a number or numbers representing an incentive data memory location, could be a simple state bit used as a flag, or could simply be the inclusion of the specific product (i.e., the product being weighed) in the incentive database. Importantly, the incentive that is linked to any specific product will typically be for a different product. Usually the different product will be a product that is complementary to the weighed product as opposed to a product that is competitive with the weighed product. For example, for a given brand of deli ham that is weighed an incentive might be provided for a product such as a particular brand of mayonnaise, mustard or potato chips. As another example, when celery or carrots are weighed an incentive might be provided for a particular brand of vegetable dip, or when salad is weighed an incentive might be provided for a particular brand of salad dressing.

As used herein the term “weighed product” will be used to refer to the product that is weighed by the scale and that may have an incentive linked therewith and the term “incentive product” will be used to refer to a product to which an incentive relates. Scale systems are also sometimes used for labeling fixed weight products or products sold by count instead of weight, in which cases the scale system may produce a label for the product without ever weighing the product. If an incentive is linked to a weighed product (or fixed weight or by count product), the controller establishes incentive print data (such as incentive product name, nature of incentive, expiration date, scannable coupon bar code, logo and/or other graphics data and label set-up and format) to be delivered to the printing mechanism 30 to print an “incentive label” that contains the incentive. The incentive label may be part of the product pricing label, with provision made for separation of the incentive label from the rest of the product pricing label. However, the incentive label might also be a label that is output separate from the product pricing label.

The incentive provided to the consumer will typically be in the form of a coupon. As used herein the term coupon is broadly used to encompass both cents off and percent off type offers, as well as 2 for the price of 1 type offers. The incentive label will typically be printed with the incentive visually stated thereon and with a coupon bar code that can be scanned at the point of sale to effect application of the incentive for a customer purchasing the incentive product, where the point of sale computer terminals access a coupon database and the coupon database links the details of any given incentive with the coupon bar code provided on the incentive label.

If the incentive label is part of the product pricing label, it will typically be applied by store personnel to a package containing the weighed product. If the incentive label is separate from the product pricing label it may be handed directly to the customer. In either case, the customer receives the incentive prior to completion of the shopping experience and therefore is more likely to actually utilize the incentive (e.g., purchase the incentive product and redeem the coupon for the incentive product).

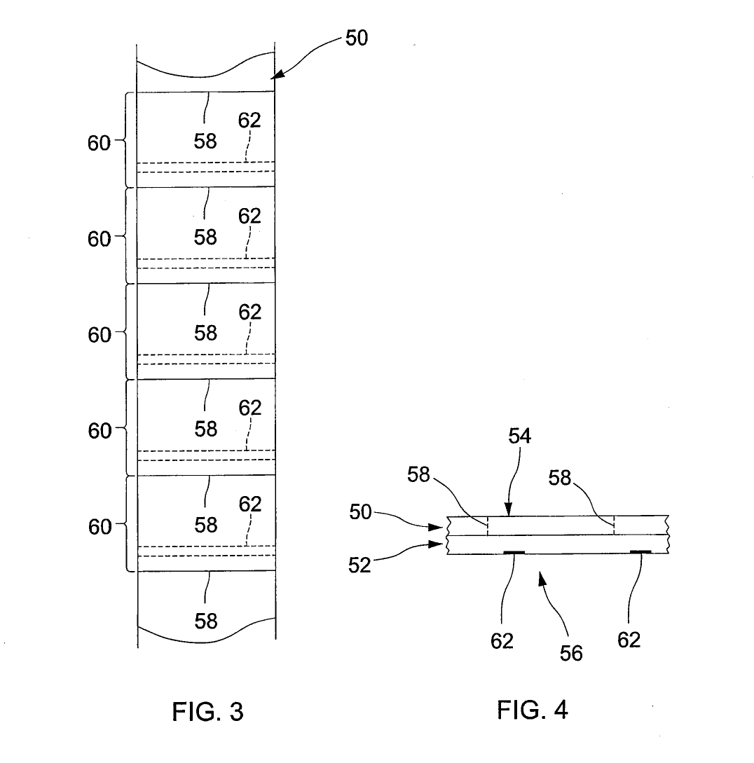

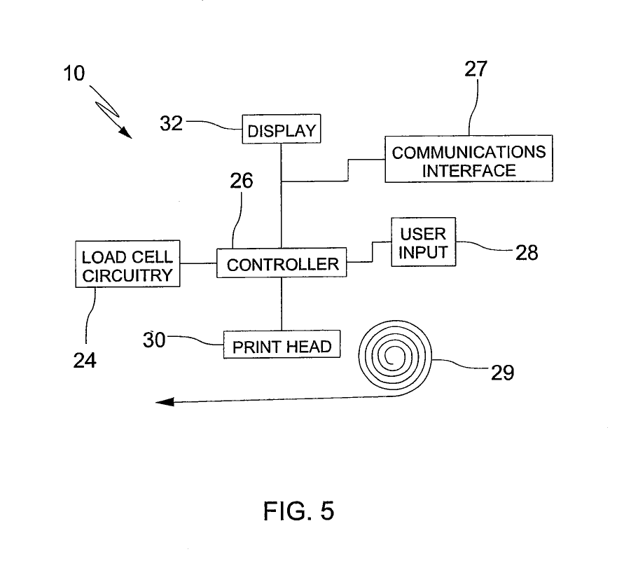

Referring to FIGS. 3-4, an exemplary label supply for use in the contemplated selective coupon distribution system is shown. Specifically, the label supply takes the form of a continuous label stock 50 on a corresponding continuous liner 52, with front side 54 of the stock used for printing on and the back side 56 of the stock being adhesive for attachment of printed labels to packages. The liner 52 includes a typical release coating to enable the adhesive labels to be separated from the liner after printing. The label stock including a series of weakening lines 58 (e.g., series of perforations, or score lines to facilitate folding or tearing of the label stock along such lines) along its length, the weakening lines being spaced apart at a predetermined distance to define multiple label segments 60 of common size, each label segment 60 further including an associated position synchronization element 62. In the illustrated embodiment the position synchronization element is a black bar printed on the back side of the liner 52. However, the position synchronization element could readily be located elsewhere (such as the front side 54 of the label stock) or could take on other forms (such as a slot or gap located at the edge of the label stock). While in the illustrated embodiment the width of the label stock 50 matches the width of the liner 52, the width of the label stock could also be narrower than that of the liner. The label supply is typically rolled and loaded for movement past a print head of the printing mechanism per FIG. 5.

It is contemplated that selective production of coupon incentives, advertisements/promotions or supplemental information, or simply a product pricing label without any coupon or advertisement/promotion or supplemental information may be produced.

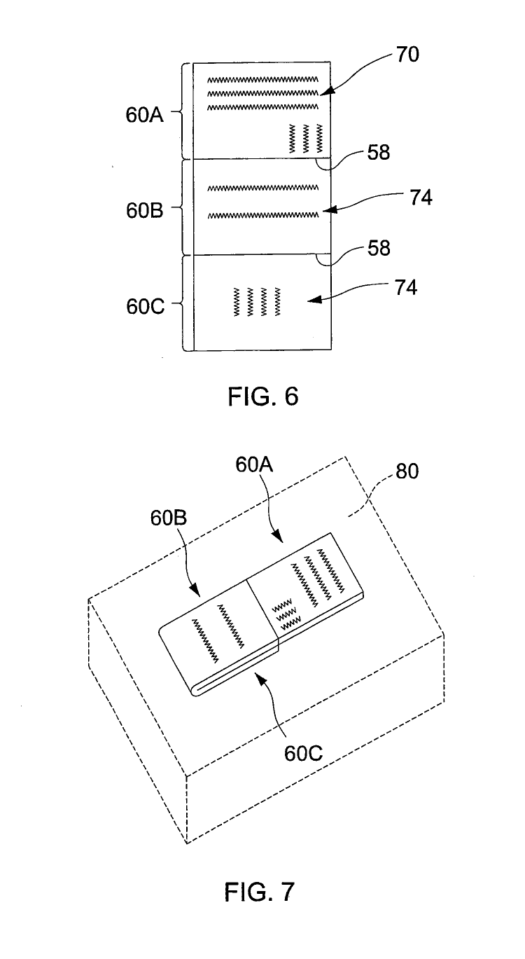

In one example, during an item weighing operation, a product to be weighed is identified to the scale (e.g., using input device 28 to enter a PLU or select from a screen). A determination is made as to whether the product to be weighed is linked to an associated coupon offer. Referring to FIG. 6, if the product to be weighed is linked to an associated coupon offer:

(i) price and product information 70 (e.g., which may included product name. printed price, and pricing bar code etc.) are printed on a first label segment 60A;

(ii) coupon information 72 (e.g., which may include incentive item name and nature of incentive) is printed on a second label segment 60 B that is immediately adjacent the first label segment 60a;

(iii) a coupon bar code 74 is printed on a third label segment 60 C that is immediately adjacent the second label segment 60B (note that information in addition to the coupon bar code could also be printed on label segment 60B);

(iv) the printed first, second and third label segments are separated, generally at or near the appropriate weakening line, (e.g., manually or by using a cutter or some other mechanical structure) from the rest of the label supply, the first, second and third label segments remaining attached together as a multi-segment label unit per FIG. 6;

(v) the third label segment 60C is folded under the second label segment 60B per FIG. 7 (because the two label segments are of common size the adhesive at the rear side of each of the segments joins the two segments together); and

(vi) the multi-segment label unit is attached (manually or automatically) to a package 80 containing the weighed product via adhesive at a rear side of the first label segment such that coupon bar code on the third label segment faces downward against the package, per FIG. 7.

The package can then be provided to a customer who can choose to use the coupon by retrieving the incentive item, tearing the coupon part (i.e, segments 60B and 60C) off of the pricing part (i.e., segment 60A) and presenting the coupon to the checkout person at checkout. If the customer does not use the coupon and the coupon remains with the product, the coupon bar code faces downward against the package to prevent scanning of the coupon bar code at checkout.

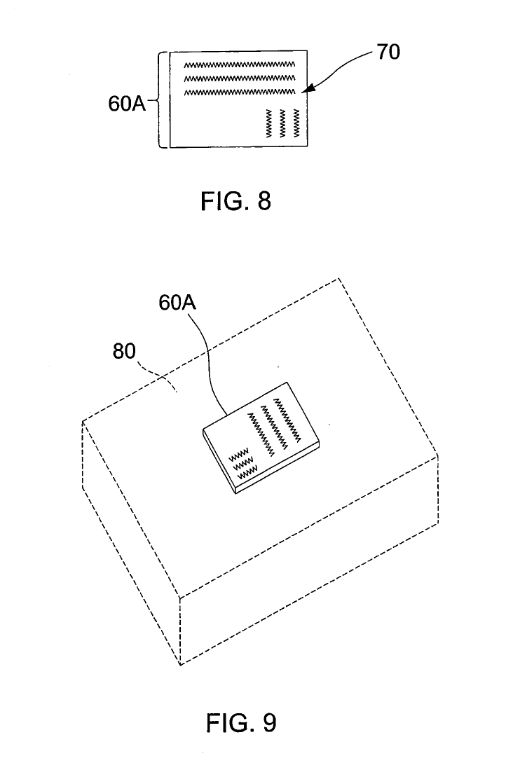

On the other hand, if the product to be weighed is not linked to an associated coupon offer, and referring to FIG. 8:

(i) price and product information 70 are printed on one label segment 60A,

(ii) the one label segment 60A is separated from the label supply, the one label segment by itself forming a single-segment label unit,

(iii) the single-segment label unit is then attached to a package 80 (FIG. 9) containing the weighed product via adhesive at the rear side of the one label segment 60A.

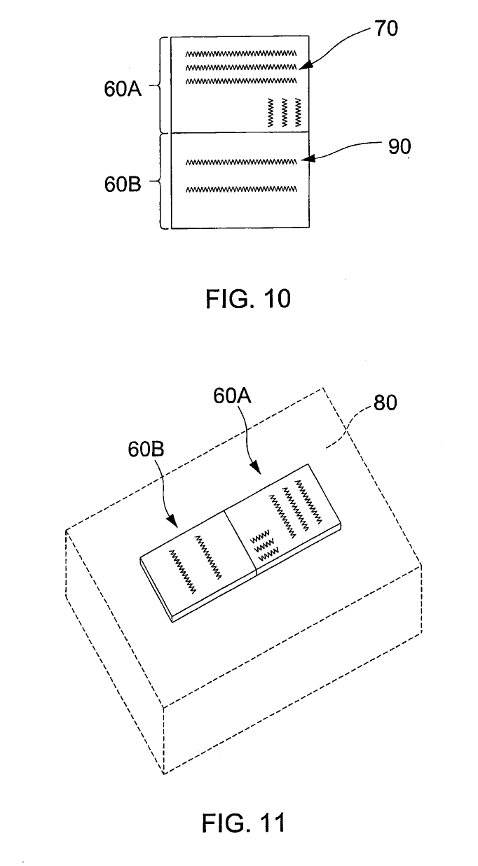

Variations are possible. For example, it is contemplated that where no coupon is printed, but where it is desired to provide a promotional message or other advertisement, the scale system could selectively produce a label taking the form of that shown in FIGS. 10 and 11 could be produced. With segment 60A containing price and produce information 70 and segment 60B containing the promotional message 80. The promotional message could be an advertisement, or it could be a notification of an electronic coupon offer (e.g., a coupon offer that does not require scanning of a coupon bar code at checkout). A similar label structure could be produced with, for example, cooking instructions, recipes etc. printed on segment 60B instead of, or in addition to the promotional message 80.

Where an item is a fixed price item (e.g., loaf of bread in the bakery) or a by count item, a similar process could take place without actually ever weighing the item. In such cases the printer need not be associated with a scale.

While certain embodiments have been described above, it is recognized that variations exist. While label supply having a liner is described, it is contemplated the linerless label supplies could also be used. For example, the linerless stock may include a heat activated adhesive, or the linerless may be a self-releasing linerless. Further, continuous linered or linerless label stock could be used in combination with a scale system printer that includes, for example, a rotary cutter blade (available from Seiko and elsewhere) that could cut the label and coupon at any desired length. The same cutter (there are usually 2 blades) or a second device could include a blade that is profiled to create a partial cut or perforation for the fold. In such cases, a synchronization mark would not be needed. Still further, the weighing, printing, separating, folding and applying operations described above could take place at various locations (e.g., at an in-store department using a deli-scale, in back-room of a store using an automated package wrapping machine, or even at a more centralized food product packaging location).

What is claimed is:

1-8. (canceled)

9. A method for selectively producing product labels in different lengths, the method comprising the steps of:
utilizing a printer system having an associated label supply, where the label supply is comprised of a continuous label stock having a series of laterally extending weakening lines spaced apart to define multiple interconnected label segments of common size;
identifying a first item for which a label is to be printed;
based upon identity of the first item, the label scale system printer prints and outputs a first label having only a single label segment of the continuous label stock;
identifying a second item, different than the first item, for which a label is to be printed;
based upon identity of the second item, the label scale system printer prints and outputs a second label having multiple label segments of the continuous label stock, where information is printed on each of the multiple label segments.

10. The method of claim 9 wherein the second label includes at least a first label segment and an adjacent second label segment and the method includes folding an adhesive side of the first label segment against an adhesive side of the second label segment.

11. The method of claim 10 wherein the second label further includes a third label segment adjacent to the second label segment.

12. The method of claim 11 wherein:
the first label is an incentive-free product pricing label that is applied to a package containing the first item;
the second label is a combined product pricing and incentive label that is applied, via an adhesive side of the third label segment, to a package containing the second item.

13. The method of claim 12 wherein:
product pricing information is printed on the third label segment and incentive information is printed on both the first label segment and the second label segment.

14. The method of claim 9 wherein:
the first label is separated as a single-segment label from the label supply at a weakening line;
the second label is separated as a multi-segment label from the label supply at a weakening line.

15. The method of claim 9 wherein each label segment of the label supply includes an associated position synchronization element at a rear side of the label supply.

16. A food product scale for selectively producing labels of different lengths, the scale comprising:
a weighing device;
an input device;
a printer with an associated label supply, where the label supply is comprised of a label stock having a series of laterally extending weakening lines spaced apart to define multiple interconnected label segments of common size;
a controller connected with the weighing device, input device and the printer, the controller programmed to:
identify an item to be weighed and priced based upon signals from the input device;
if the item to be weighed and priced is a first specific item:
cause the printer to print and output first label that is a single label segment label;
if the item to be weighed and priced is a first specific item:
cause the printer to print and output a second label that is a multiple label segment label in which information is printed on at least two adjacent label segments of the label supply.

17. The food product scale of claim 16 wherein the second label includes at least first, second and third label segments.

18. The food product scale of claim 17 wherein:
the first label is an incentive-free product pricing label with product pricing information printed thereon;
the second label is a combined product pricing and incentive label with both product pricing information and incentive information printed thereon.

19. The food product scale of claim 16 wherein each label segment of the label supply includes an associated position synchronization element at a rear side of the label supply.
